(19) United States
(12) Patent Application Publication
(10) Pub. No.: US 2012/0155434 A1
(43) Pub. Date: Jun. 21, 2012

(54) METHOD AND APPARATUS FOR TRANSMITTING UPLINK CONTROL SIGNALS IN WIRELESS COMMUNICATION SYSTEM

(75) Inventor: Ki Hyuk PARK, Daejeon (KR)

(73) Assignee: Electronics and Telecommunications Research Institute, Daejeon (KR)

(21) Appl. No.: 13/324,978

(22) Filed: Dec. 13, 2011

(30) Foreign Application Priority Data
Dec. 16, 2010 (KR) 10-2010-0129507

(51) Int. Cl. H04W 72/04; H04B 1/707; H04B 7/216

(52) U.S. Cl. 370/335; 375/E01.002

(57) ABSTRACT

Disclosed are an apparatus and a method transmitting uplink control signals. The method for transmitting uplink control signals includes allocating resources on an uplink control channel commonly used by a first control signal requesting an uplink data channel and a second control signal requesting automatic retransmission to a transmitter; transforming the first control signal and the second control signal into a predetermined symbol; changing a phase of the transformed and output symbol, when the first control signal is transmitted or when the first control signal and the second signal are simultaneously transmitted; and spreading an output symbol of which the phase is changed by a spreading code to transmit the spread output symbol using the resources on the allocated uplink control channel.

### CROSS-REFERENCES TO RELATED APPLICATIONS

The present application claims priority under 35 U.S.C 119(a) to Korean Application No. 10-2010-0129507, filed on Dec. 16, 2010, in the Korean Intellectual Property Office, which is incorporated herein by reference in its entirety set forth in full.

### BACKGROUND

Exemplary embodiments relate to a wireless communication system, and more particularly, to a method and an apparatus for transmitting uplink control signals in a wireless communication system.

With a rapid increase of a demand for mobile multimedia services, research and development for next-generation wireless broadband multimedia communication system has been actively conducted around the world. In order to effectively overcome distortions due to a wireless channel occurring in the wireless communication system while supporting a high data transmission rate, a smart antenna technology such as space time diversity coding (STC), adaptive antenna system (AAS), spatial multiplexing (SM), or the like, so as to maximize resource efficiency in a time domain, a frequency domain, and a space region, based on an orthogonal frequency division multiplexing (OFDM) scheme has been applied.

The wireless communication system is divided into a downlink channel transmitted from a base station to a terminal and an uplink channel transmitted from the terminal to the base station. Each link channel is divided into a data channel and a control channel for transmitting data. An example of the control signals transmitted through the uplink control channel may include a scheduling request requesting uplink resource allocation, Hybrid-Automatic Repeat-reQuest (HARQ) ACK/NACK control signal that is an automatic retransmission request response to downlink data transmission, a Channel Quality Indicator (CQI) indicating downlink channel quality, a Precoding Matrix Index (PMI), an Rank Indicator (RI), or the like.

FIG. 1 is a diagram illustrating an example of a method for transmitting the scheduling request control signals and the HARQ ACK/NACK control signals through the uplink control channel in the wireless communication system.

The control channel for transmitting the uplink control signals is a Physical Uplink Control Channel (PUCCH). The scheduling request control signal is transformed into Binary PhaseShift Key (BPSK) symbol ‘1’ through a BPSK/QPSK (Quadrature Phase Shift Keying) symbol mapper. When the H-ARQ/NACK control signal is 1-bit, the H-ARQ/NACK control signal is transformed into the BPSK symbol and when the H-ARQ/NACK control signal is 2-bit, the H-ARQ/NACK control signal is transformed into the QPSK symbol. FIG. 2 shows a symbol constellation diagram of the BPSK/QPSK symbol mapper.

When transmitting the scheduling request control signals, a single scheduling request symbol configures a total of four OFDM symbols from the first two to the last two among seven OFDM symbols and a demodulation reference signal (DMRS) configures the middle three OFDM symbols. The scheduling request symbol is spread to a phase-rotated sequence such as Zadoff-Chu sequence and is then spread by being again multiplied by an orthogonal code. The spread symbol is carried on a single resource block (RB) resource allocated to the scheduling request control signal and is subjected to IFFT transform and then, transmitted.

When transmitting the H-ARQ ACK/NACK control signals, a single H-ARQ ACK/NACK symbol configures a total of four OFDM symbols from the first two to the last two among seven OFDM symbols and the demodulation reference signal (DMRS) configures the middle three OFDM symbols. The H-ARQ symbol is spread to the phase-rotated sequence such as the Zadoff-Chu sequence and is then spread by being again multiplied by the orthogonal code. The spread symbol is carried on the single resource block (RB) resource allocated to the H-ARQ ACK/NACK control signals and is subjected to the IFFT transform and then, transmitted.

FIG. 3 is a diagram illustrating a method for simultaneously transmitting the scheduling request and the H-ARQ ACK/NACK control signals in the wireless communication system according to the related art. Data is not carried on the resources allocated to the H-ARQ ACK/NACK, and the H-ARQ ACK/NACK control signals are transmitted by being carried on the resources allocated to the scheduling requesting. The base station knows the timing when the terminal transmits the H-ARQ ACK/NACK control signals and thus, detects energy in the resources allocated to the scheduling request and the resources allocated to the H-ARQ ACK/NACK, respectively, and compares two values. When the energy detected in the resource allocated to the scheduling request is larger, the base station determines that the scheduling request and the H-ARQ ACK/NACK control signals are transmitted together to demodulate the H-ARQ ACK/NACK control signals and perform the processing on the scheduling request of the terminal. When the energy detected in the H-ARQ ACK/NACK resource is larger, the base station determines that the terminal transmits only the H-ARQ ACK/NACK control signals without the scheduling request to demodulate the signal in the H-ARQ ACK/NACK resource.

In order for the terminal to receive the resource allocation for data transmission to the base station, the scheduling request control signals are transmitted by being carried on the resources on the uplink control channel allocated for the scheduling request. The H-ARQ ACK/ANCK is the automatic retransmission request response to the downlink data transmission is transmitted through the resources allocated for the H-ARQ ACK/NACK control signals on the uplink control channel. At this time, the base station previously knows the time when the terminal transmits the H-ARQ ACK/NACK response that is the automatic retransmission request response to the downlink data transmission. In addition, when the terminal simultaneously transmits the scheduling request and the H-ARQ response, a need exists for a efficient control channel structure for simultaneously transmitting the control signals.

The above technology configuration is a background art for helping to understand the present invention but does not mean the related art well-known in the art to which the present invention pertains.

The related art needs to allocate the uplink control channel resources to each of the scheduling request and the H-ARQ ACK/NACK so as to transmit the scheduling request and the H-ARQ response, thereby causing the waste of the control channel resources.

In the case of a Long Term Evolution (LTE) system, different resources are allocated to the scheduling request and the H-ARQ ACK/NACK so as to transmit the scheduling request and the H-ARQ ACK/NACK control signals. However, when simultaneously transmitting the scheduling request and the H-ARQ ACK/NACK control signals, the H-ARQ ACK/NACK control signals are transmitted through the uplink control channel resources allocated for the scheduling request.

Therefore, a receiver demodulates whether the data are carried on the resource allocated to the scheduling request and the resource allocated to the H-ARQ ACK/NACK, respectively, thereby increasing complexity at the time of implementing hardware.

### SUMMARY

An object of the present invention is to provide a method and an apparatus for transmitting uplink control signals in a wireless communication system capable of greatly reducing uplink control channel resources allocated.

In addition, another object of the present invention is to provide a method and an apparatus for transmitting uplink control signals in a wireless communication system capable of reducing complexity of a receiver while performing effective transmission using only an uplink control channel resource in separately or simultaneously transmitting a scheduling request and H-ARQ ACK/NACK, respectively, that are uplink control signals.

An embodiment of the present invention relates to a method for transmitting uplink control signals in a wireless communication system, including: allocating resources on an uplink control channel commonly used by a first control signal requesting an uplink data channel and a second control signal requesting automatic retransmission to a transmitter; transforming the first control signal and the second control signal into a predetermined symbol; changing a phase of the symbol that is transformed and output, when the first control signal is transmitted or when the first control signal and the second signal are simultaneously transmitted; and spreading the output symbol of which the phase is changed by a spreading code to transmit the spread output symbol using the resources on the allocated uplink control channel.

In one embodiment, the first control signal may be a scheduling request control signal and the second control signal is an H-ARQ ACK/NACK control signal.

In one embodiment, at the transforming of the symbol phase, a rotation size of the phase of the output symbol may be π/4.

In one embodiment, at the transforming of the symbol, the first control signal and the second control signal are transformed into a BPSK or QPSK symbol.

In one embodiment, the method for transmitting uplink control signals may further include spreading the output symbol of the first control signal or the second control signal by a spreading code without changing the phase to transmit the spread output symbol using the resources on the allocated uplink control channel, when the first control signal and the second control signal are not simultaneously transmitted.

Another embodiment of the present invention relates to an apparatus for transmitting uplink control signals in a wireless communication system, including: a resource allocation unit allocating resources on an uplink control channel commonly used by a first control signal requesting an uplink data channel and a second control signal requesting automatic retransmission to a transmitter; a symbol mapper transforming the first control signal and the second control signal into a predetermined symbol; a phase rotation unit changing the phase of the second control signal symbol that is transformed and output, when the first control signal and the second control signal are simultaneously transmitted; and a transmitter spreading the output symbol of which the phase is changed by a spreading code to transmit the spread output symbol using the resources on the allocated uplink control channel.

In one embodiment, the first control signal may be a scheduling request control signal and the second control signal may be an H-ARQ ACK/NACK control signal.

In one embodiment, the phase rotation unit may rotate the phase of the output symbol by π/4.

In one embodiment, the symbol mapper may transform the first control signal and the second control signal into a BPSK or QPSK symbol.

### BRIEF DESCRIPTION OF THE DRAWINGS

The above and other aspects, features and other advantages will be more clearly understood from the following detailed description taken in conjunction with the accompanying drawings, in which:

FIG. 1 is a diagram illustrating a method for transmitting each uplink control signal;

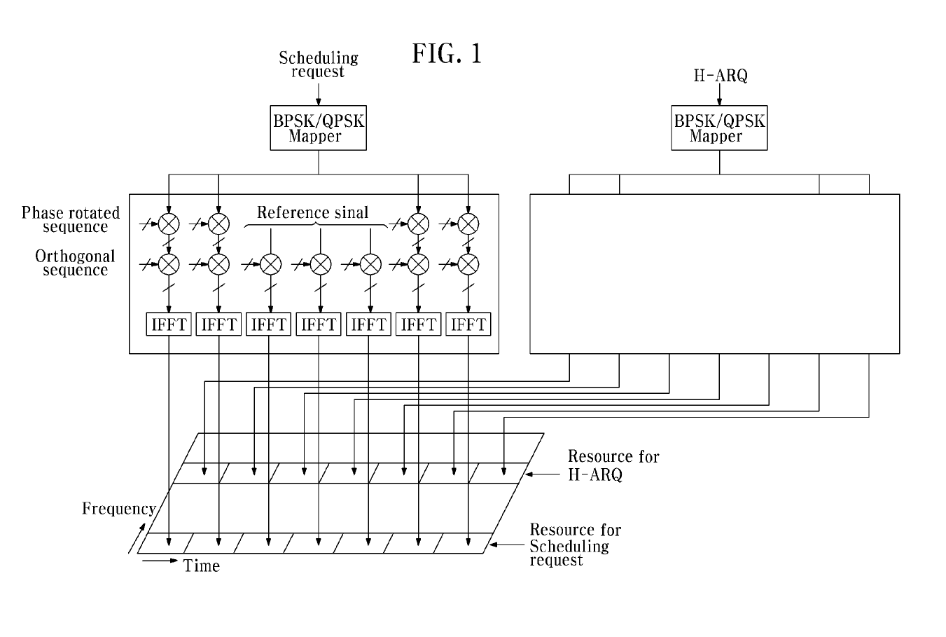

FIG. 2 shows a constellation diagram of a BPSK/QPSK symbol mapper;

FIG. 3 is a diagram illustrating a method for simultaneously transmitting two control signals;

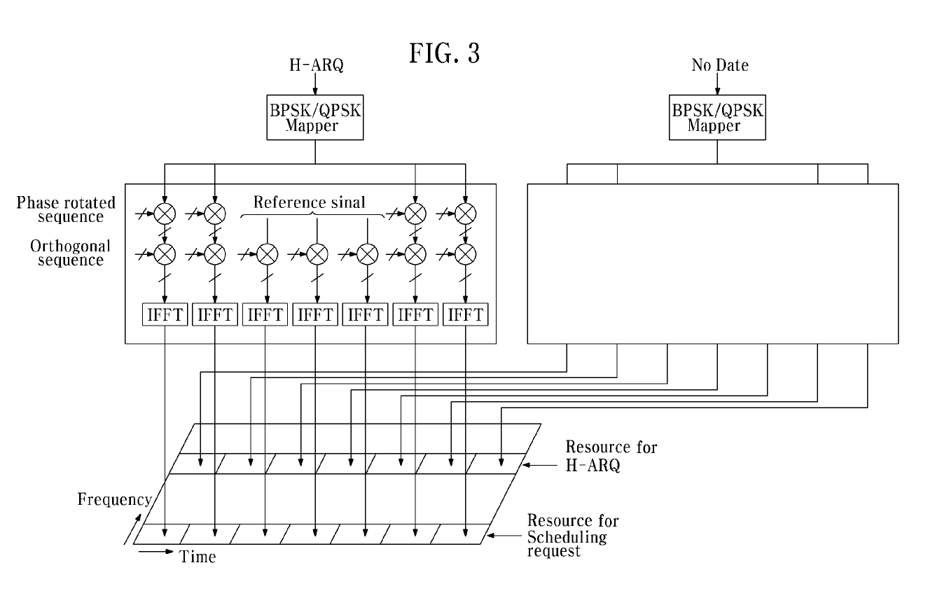

FIG. 4 is a block diagram of a configuration for an apparatus for transmitting uplink control signals in accordance with an embodiment of the present invention;

FIG. 5 is a diagram illustrating a method for transmitting two control signals using a single uplink control channel resource in accordance with the embodiment of the present invention;

FIG. 6 is a constellation diagram of an output from a phase rotation unit in accordance with an embodiment of the present invention; and

FIG. 7 shows a flow chart of a method for transmitting uplink control signals in accordance with the embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

In describing the embodiment, a thickness of lines illustrated in the drawings, a size of components, etc., may be exaggeratedly illustrated for clearness and convenience of explanation. In addition, terms described to be below are terms defined in consideration of functions in the present invention, which may be changed according to the intention or practice of a user or an operator. Therefore, these terms will be defined based on contents throughout the specification.

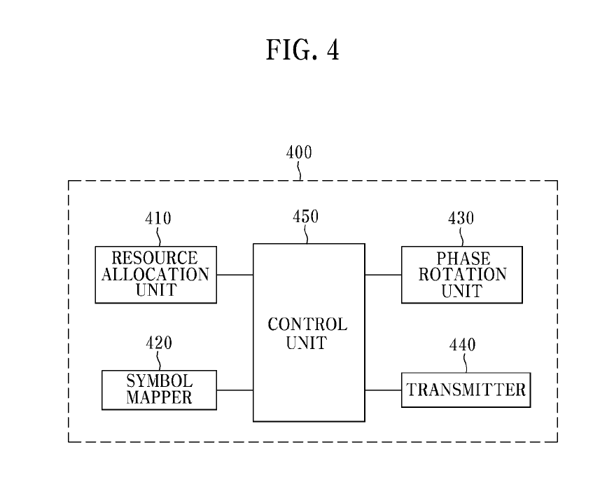

FIG. 4 is a block diagram of a configuration for an apparatus for transmitting uplink control signals in accordance with an embodiment of the present invention.

An embodiment of the present invention change a transmitted symbol mapping scheme according to when only scheduling request control signals are transmitted, when only H-ARQ ACK/NACK control signals are transmitted, and when the scheduling request and the H-ARQ ACK/NACK control signals are simultaneously transmitted to transmit two types of control signals using only a single control signal resource.

Referring to FIG. 4, an apparatus 400 for transmitting uplink control signals includes a resource allocation unit 410, a symbol mapper 420, a phase rotation unit 430, a transmitter 440, and a control unit 450.

The resource allocation unit 410 may allocate resources on an uplink control channel that are commonly used by a first control signal and a second control signal requesting the uplink data channel. In this case, the first control signal is a scheduling request control signal and the second control signal is an H-ARQ ACK/NACK control signal.

The symbol mapper 420 may transform the first control signal and the second control signal into a predetermined symbol.

In this case, the first control signal and the second control signal are transformed into BPSK or QPSK symbols.

The phase rotation unit 430 may change the phases of the symbols that are transformed and output when the first control signal and the second control signal are simultaneously transmitted and the transmitter 440 spreads the output symbol, of which the phase is changed, by a spreading code to transmit the spread output symbol using the resources on the allocated uplink control channel.

In this case, when the first control signal and the second control signal are not simultaneously transmitted, the phase rotation unit 430 does not change the phase of the output symbol of the first control signal or the second control signal and the transmitter 440 spreads the output symbol, of which the phase is not changed, by a spreading code to transmit the spread output symbol using the resources on the allocated uplink control channel.

The control unit 450 controls a resource allocation unit 410, a symbol mapper 420, a phase rotation unit 430, and a transmitter 440, respectively.

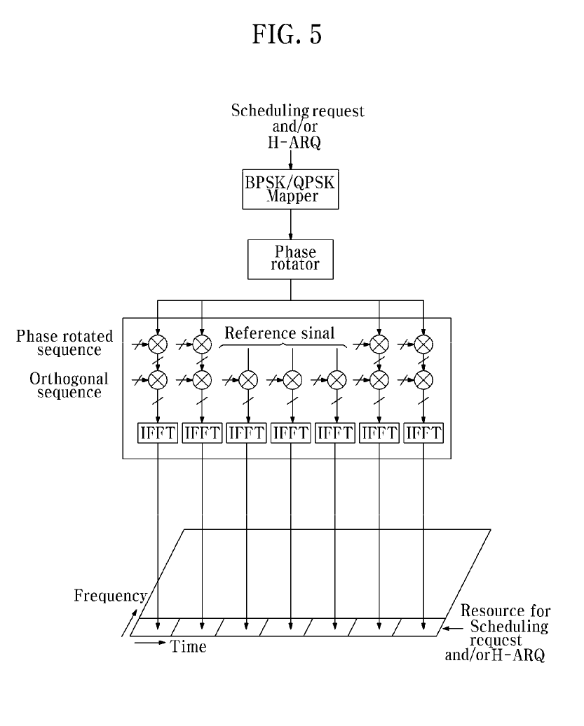

FIG. 5 is a diagram showing an embodiment of the present invention.

The embodiment of the present invention uses only a single resource so as to transmit the scheduling request and the H-ARQ ACK/NACK control signal. The phase rotation unit rotates the phase of the BPSK/QPSK symbol mapper output by π/4 only when the scheduling request and the H-ARQ ACK/NACK control signal are simultaneously transmitted. In this case, the phase of the symbol mapper output may be rotated by angles other than π/4.

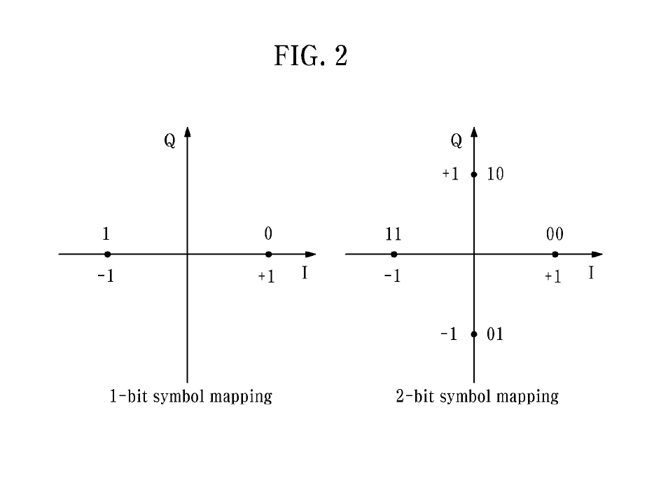

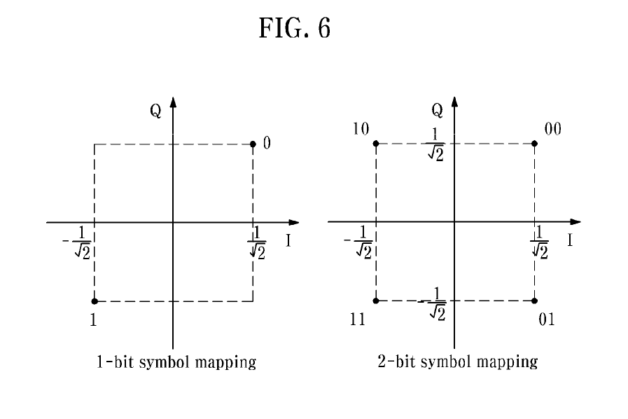

FIG. 6 shows a constellation diagram of the output from the rotated phase rotation unit. Therefore, when only the scheduling request is transmitted or only the H-ARQ ACK/NACK is transmitted, the scheduling request symbol or the H-ARQ ACK/NACK symbol are spread without π/4 phase rotation and are transmitted by being carried on the common control resource. In this case, the base station may differentiate whether the terminal transmits the scheduling request or the H-ARQ ACK/NACK when the symbols mapped by the constellation diagram as illustrated in FIG. 2 are demodulated, since the terminal knows the time when the H-ARQ ACK/NACK is transmitted. When the base station demodulates the π/4 phase-rotated symbols as illustrated in FIG. 6, the base station determines that the demodulated symbol is the H-ARQ ACK/NACK control signal and the terminal simultaneously transmits the scheduling request and the H-ARQ ACK/NACK, such that the base station allocates the uplink data channel to the terminal.

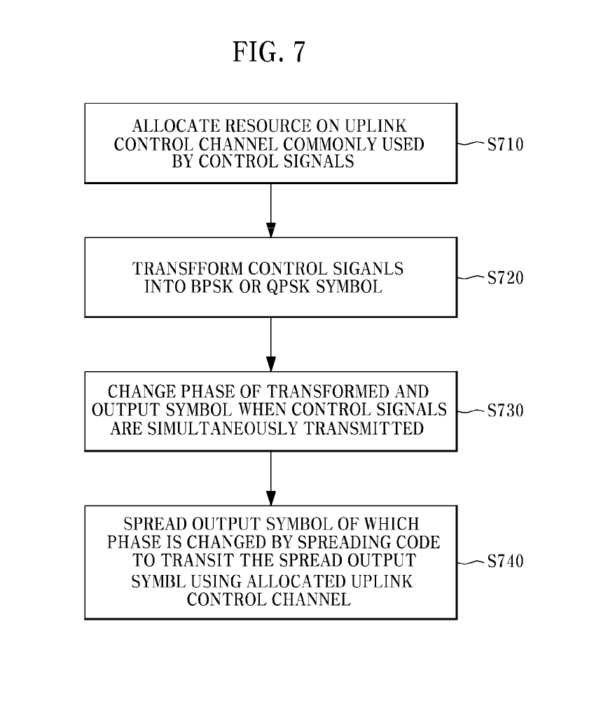

FIG. 7 shows a flow chart of a method for transmitting uplink control signals in accordance with the embodiment of the present invention. Each step to be described below may be performed in each component of the wireless communication system.

First, the resources on the uplink control channel commonly used by the first control signal and the second control signal requesting the uplink data channel are allocated (S710). In this case, the first control signal may be a scheduling request control signal and the second control signal may be the H-ARQ ACK/NACK control signals and may also be other control signals.

When the resources on the uplink control channel resource are allocated, the first control signal and the second control signal are transformed into the predetermined symbol (S720). In this case, the symbol into which the first control signal and the second control symbol are transformed may be the BPSK or the QPSK symbol and may be transformed into other symbols.

Thereafter, when the first control signal and the second control signal are simultaneously transmitted, the phase of the transformed and output symbol is changed (S730) and the output symbol of which the phase is changed is spread by the spreading code and is transmitted using the resources on the uplink control channel previously allocated at step S710 (S740).

In the detailed device configuration of the apparatus and the method for transmitting uplink control signal in accordance with the embodiment of the present invention, an embedded system, a common platform technology such as O/S, or the like, and a communication protocol, an I/O interface, or the like, is apparent to those skilled in the art and the detailed description thereof will be omitted.

As set forth above, the exemplary embodiments of the present invention can maximally reduce the uplink control channel resources allocated so as to transmit the uplink control signals by allowing two control signals to commonly use the uplink control channel in transmitting the scheduling request and the H-ARQ ACK/NACK that are the uplink control signals and effectively reduce the complexity of the receiver by demodulating only the single uplink control channel resource so as to receive two types of control signals at the receiving end.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A method for transmitting uplink control signals in a wireless communication system, comprising:
allocating resources on an uplink control channel commonly used by a first control signal requesting an uplink data channel and a second control signal requesting automatic retransmission to a transmitter;
transforming the first control signal and the second control signal into a predetermined symbol;
changing a phase of the transformed and output symbol, when the first control signal is transmitted or when the first control signal and the second signal are simultaneously transmitted; and
spreading the output symbol of which the phase is changed by a spreading code to transmit the spread output symbol using the resources on the allocated uplink control channel.

2. The method of claim 1, wherein the first control signal is a scheduling request control signal and the second control signal is an H-ARQ ACK/NACK control signal.

3. The method of claim 1, wherein at the step of transforming of the symbol phase, a rotation size of the phase of the output symbol is π/4.

4. The method of claim 1, wherein at the step of transforming of the symbol, the first control signal and the second control signal are transformed into a BPSK or QPSK symbol.

5. The method of claim 1, further comprising spreading the output symbol of the first control signal or the second control signal by a spreading code without changing the phase to transmit the spread output symbol using the resources on the allocated uplink control channel, when the first control signal and the second control signal are not simultaneously transmitted.

6. An apparatus for transmitting uplink control signal in a wireless communication system, comprising:
a resource allocation unit allocating resources on an uplink control channel commonly used by a first control signal requesting an uplink data channel and a second control signal requesting automatic retransmission to a transmitter;
a symbol mapper transforming the first control signal and the second control signal into a predetermined symbol;
a phase rotation unit changing a phase of the transformed and output second control signal symbol, when the first control signal and the second control signal are simultaneously transmitted; and
a transmitter spreading the output symbol of which the phase is changed by a spreading code to transmit the spread output symbol using the resources on the allocated uplink control channel.

7. The apparatus of claim 6, wherein the first control signal is a scheduling request control signal and the second control signal is an H-ARQ ACK/NACK control signal.

8. The apparatus of claim 6, wherein the phase rotation unit rotates the phase of the output symbol by π/4.

9. The apparatus of claim 6, wherein the symbol mapper transforms the first control signal and the second control signal into a BPSK or QPSK symbol.
